(19) United States
(12) Patent Application Publication
(10) Pub. No.: US 2014/0326590 A1
(43) Pub. Date: Nov. 6, 2014

(54) PUSHBUTTON SWITCH HAVING A ROTATABLE DRIVE MEMBER

(71) Applicant: EXCEL CELL ELECTRONIC CO., LTD., Taichung City (TW)

(72) Inventor: Wei-Tzu LI, Taichung City (TW)

(73) Assignee: EXCEL CELL ELECTRONIC CO., LTD., Taichung City (TW)

(21) Appl. No.: 14/210,615

(22) Filed: Mar. 14, 2014

(30) Foreign Application Priority Data
May 1, 2013 (TW) 102115593

(51) Int. Cl. H01H 13/58

(52) U.S. Cl. CPC H01H 13/58
USPC 200/528

(57) ABSTRACT

A pushbutton switch includes a shell body, a resilient member, and a movable unit movable relative to the shell body between an upper limit position and a lower limit position. The movable unit includes a drive member and an electrical contact member driven by the drive member to move between a plurality of contact positions and a plurality of non-contact positions. The drive member has a plurality of inclined rod-engaging surfaces. When the movable unit is moved from the upper limit position to the lower limit position, one of the rod-engaging surfaces moves on a guide rod of the shell body, thereby resulting in rotation of the drive member relative to the shell body so as to covert the electrical contact member between the contact positions and the non-contact positions.

### CROSS-REFERENCE TO RELATED APPLICATION

This application claims priority of Taiwanese Application No. 102115593, filed on May 1, 2013.

### BACKGROUND OF THE INVENTION

1. Field of the Invention

This invention relates to a pushbutton switch, and more particularly to a pushbutton switch having a rotatable drive member.

2. Description of the Related Art

Referring to FIGS. 1 and 2, a conventional pushbutton switch 1 includes a base 11, a shell 12, a rotatable contact plate 13, a rotatable drive member 14 permitting the contact plate 13 to be inserted thereinto, a resilient member 15 sleeved on the rotatable drive member 14, a motion-converting member 16 biased by the resilient member 15 and sleeved on the rotatable drive member 14, and a pushbutton 17 sleeved on the motion-converting member 16, and a plurality of conductive plates 18 disposed on the base 11. The contact plate 13, the rotatable drive member 14, the resilient member 15, the motion-converting member 16, and the conductive plates 18 are disposed between the base 11 and the shell 12.

The shell 12 has an inner wall surface 121 surrounding an axis (I), a plurality of guiding ribs 122 each having a first guiding inclined surface 123 at a lower end thereof, and a plurality of guide slots 124 each defined between two adjacent ribs 123. The motion-converting member 16 has an outer peripheral surface 161, a plurality of limiting ribs 162 projecting from the outer peripheral surface 161 and each having a second guiding inclined surface 163 at an upper end thereof, and a plurality of first ratchet teeth 164 each defined between two adjacent limiting ribs 162. The pushbutton 17 has a lower end formed with a plurality of second ratchet teeth 171 engageable with the first ratchet teeth 164.

The pushbutton 17 is operable to move the motion-converting member 16 downwardly to engage the first and second guiding inclined surfaces 123, 163. At this time, the resilient member 16 is compressed to provide a biasing force to move the second guiding inclined surfaces 163 on the first guiding inclined surfaces 123 to thereby rotate the motion-converting member 16 relative to the shell body 2. In this manner, the rotatable drive member 14 and the contact plate 13 can be rotated relative to the conductive plates 18 to change the pushbutton switch 1 between an ON state and an OFF state. For example, after the pushbutton 17 is pressed to convert the pushbutton switch 1 to the ON state, it can be pressed again to covert the pushbutton switch 1 to the OFF state.

The aforesaid conventional pushbutton switch 1 suffers from the following disadvantages:
1. Since the first and second guiding inclined surfaces 123, 163 are disposed respectively at the shell body 12 and the motion-converting member 16, and since the first and second ratchet teeth 164, 171 are disposed respectively at the motion-converting member 16 and the pushbutton 17, the number of the components and the manufacturing precision are increased.
2. When the first guiding inclined surfaces 123 move on the second guiding inclined surfaces 163, friction occurs therebetween, thereby affecting adversely smooth operation of the pushbutton 17. Furthermore, when the ribs 162 are biased by the resilient member 15 to move upwardly to strike walls 125 defining upper ends of the guide slots 124, relatively large noise is created, thereby causing discomfort to the user.

### SUMMARY OF THE INVENTION

The object of this invention is to provide a pushbutton switch that can reduce effectively friction, manufacturing precision, and noise.

According to this invention, a pushbutton switch includes a shell body, a resilient member, and a movable unit movable relative to the shell body between an upper limit position and a lower limit position. The movable unit includes a drive member and an electrical contact member driven by the drive member to move between a plurality of contact positions and a plurality of non-contact positions. The drive member has a plurality of inclined rod-engaging surfaces. When the movable unit is moved from the upper limit position to the lower limit position, one of the rod-engaging surfaces moves on a guide rod of the shell body, thereby resulting in rotation of the drive member relative to the shell body so as to covert the electrical contact member between the contact positions and the non-contact positions

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is an exploded perspective view of a conventional pushbutton switch;

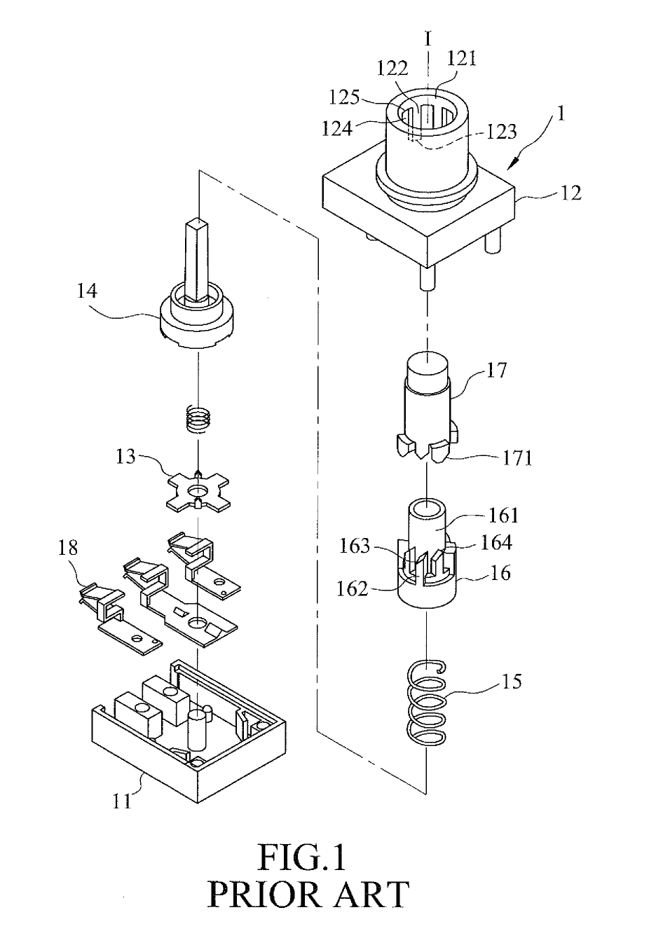

FIG. 2 is a sectional view of the conventional pushbutton switch;

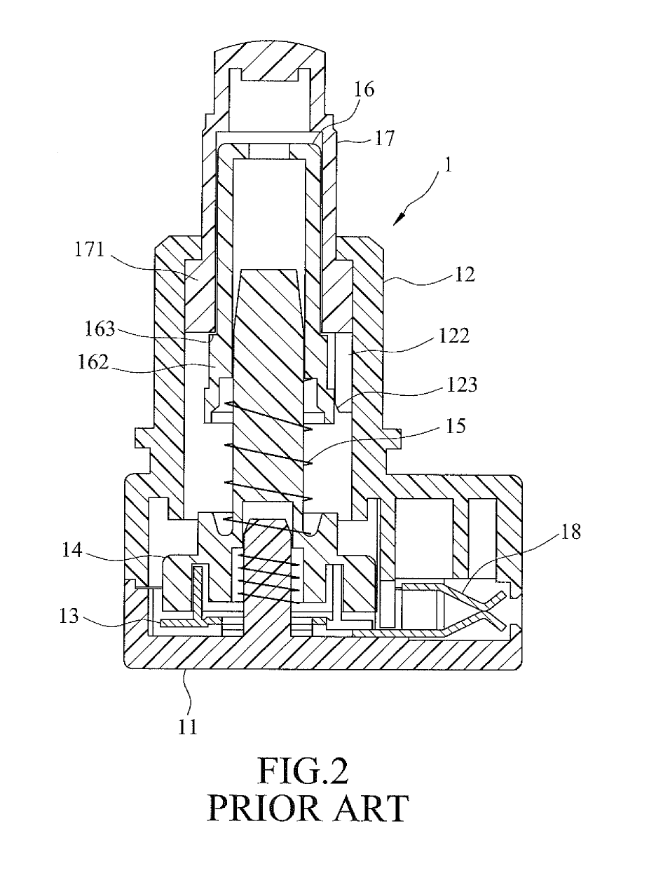

FIG. 3 is an exploded perspective view of the preferred embodiment of a pushbutton switch according to this invention;

FIG. 4 is a sectional view of the preferred embodiment, illustrating that a movable unit is disposed at an upper limit position;

FIG. 5 is a view similar to FIG. 4 but illustrating that the movable unit is disposed at a lower limit position;

FIG. 6 is a partly sectional perspective view of the preferred embodiment;

FIG. 7 is a view similar to FIG. 6 but illustrating that a downward pressure is applied to a pushbutton to move downwardly and rotate a drive member;

FIG. 8 is a view similar to FIG. 6 but illustrating that the movable unit is moved to the lower limit position to thereby compress a resilient member;

FIG. 9 is a view similar to FIG. 6 but illustrating that the downward pressure is released so that the movable unit is biased by the resilient member to move to the upper limit position;

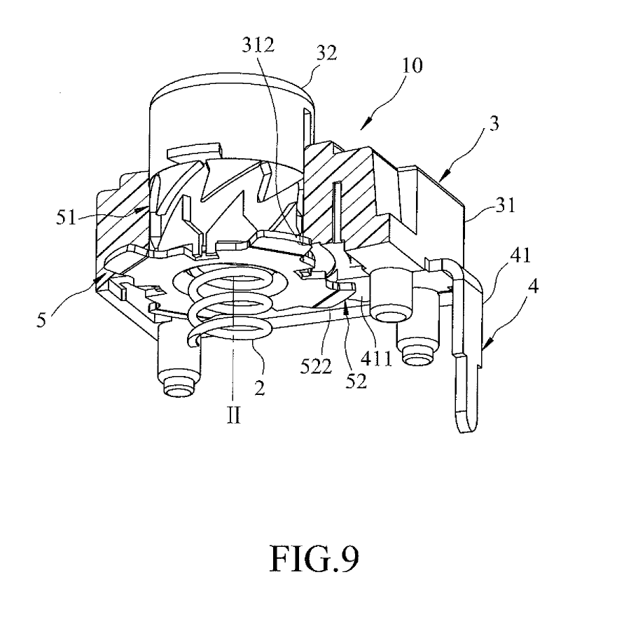

FIGS. 10A, 10B, 10C, and 10D are schematic views illustrating the motion of the movable unit relative to a guide rod when the pushbutton is pressed and subsequently released;

FIG. 11 is a top view of the preferred embodiment, illustrating that an electrical contact member is not in contact with an electrical connection unit; and

FIG. 12 is a top view of the preferred embodiment, illustrating that the electrical contact member is in contact with the electrical connection unit.

### DETAILED DESCRIPTION OF THE PREFERRED EMBODIMENT

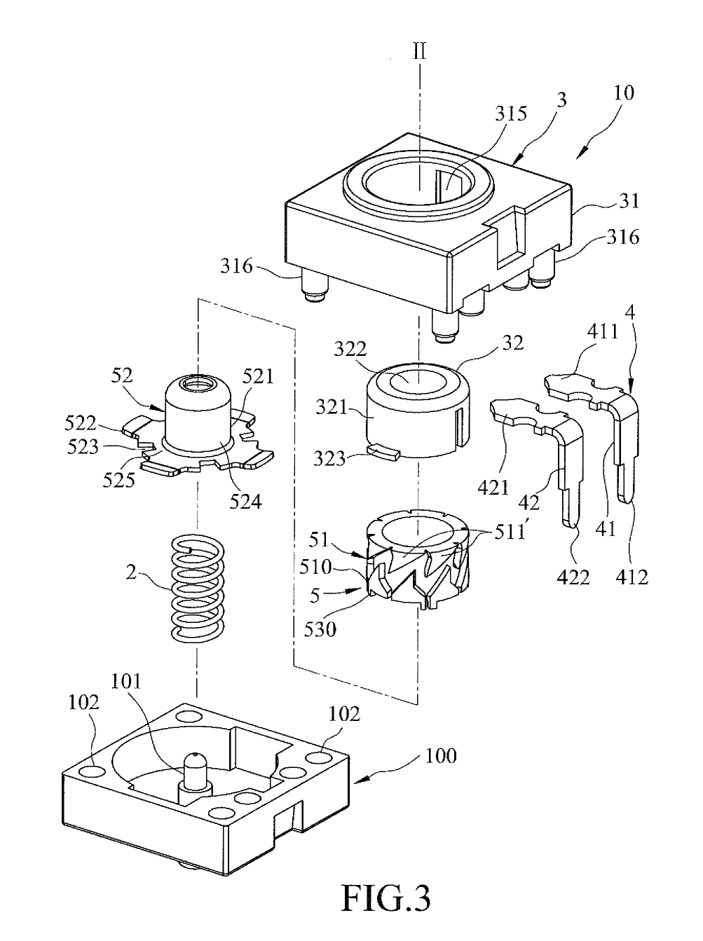

Referring to FIGS. 3, 4, and 6, the preferred embodiment of a pushbutton switch 10 according to this invention is adapted to be mounted on and above a base 100, and includes a resilient member 2 disposed on the base 100, a cover unit 3 connected to the base 100, an electrical connection unit 4 disposed between the cover unit 3 and the base 100, and a movable unit 5 disposed between the resilient member 2 and cover unit 3.

The resilient member 2 is disposed on the base 100 along an axis (II). In this embodiment, the resilient member 2 is configured as a coiled compression spring, and the base 100 and the cover unit 3 are separate members. The base 100 includes a support post 101 extending upwardly therefrom and permitting the resilient member 2 to be sleeved thereon, and a plurality of mounting holes 102. The base 100 may be molded on an electronic or electrical product (not shown).

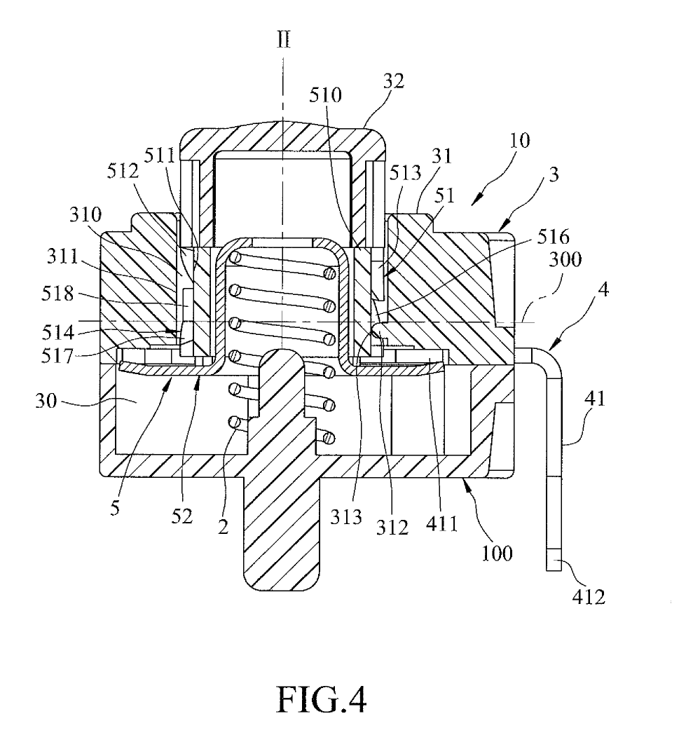

The cover unit 3 includes a shell body 31 connected with the base 100 to define an accommodating space 30 therebetween for receiving the resilient member 2, and a pushbutton 32 positioned such that the movable unit 5 is disposed between the resilient member 2 and the pushbutton 32. The shell body 31 includes an inner surrounding wall surface 311 surrounding the axis (II) and defining a passage 310 in spatial communication with the accommodating space 30, a guide rod 312 extending from the inner surrounding surface 311 toward the axis (II) and defining a reference plane 300 that is perpendicular to the axis (II), a plurality of connecting posts 316 respectively press fit into the mounting holes 102 in the base 100. The guide rod 312 has a top side located in the reference plane 300. The pushbutton 32 is movable vertically relative to the shell body 31 along the passage 310. In this embodiment, the guide rod 312 has a circular cross-section, and a rounded free end 313 (see FIG. 4).

The electrical connection unit 4 extends into the accommodating space 30 in the cover unit 3. In this embodiment, the electrical connection unit 4 includes two conductive pins 41, 42 each having a first end 411, 421 extending into the accommodating space 30, and a second end 412, 422 disposed outwardly of the cover unit 3. The connecting posts 316 of the shell body 31 are positioned to prevent movement of the conductive pins 41 of the electrical connection unit 4 relative to the base 100.

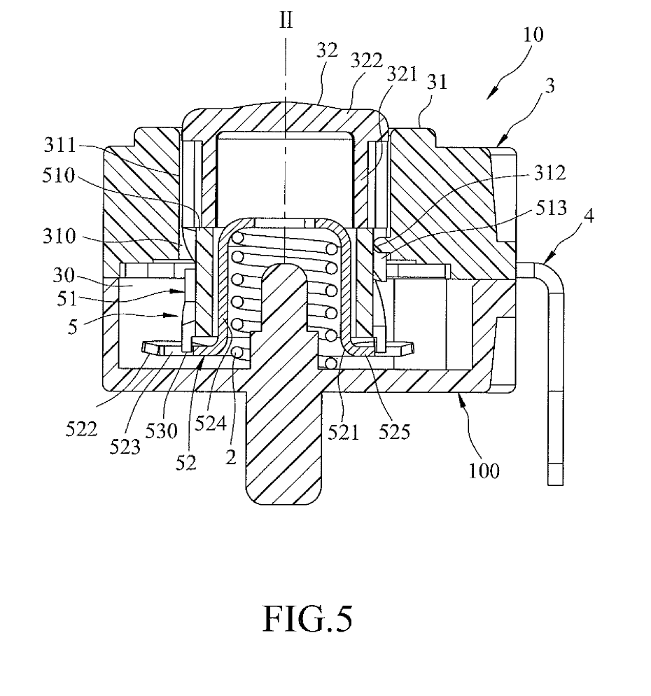

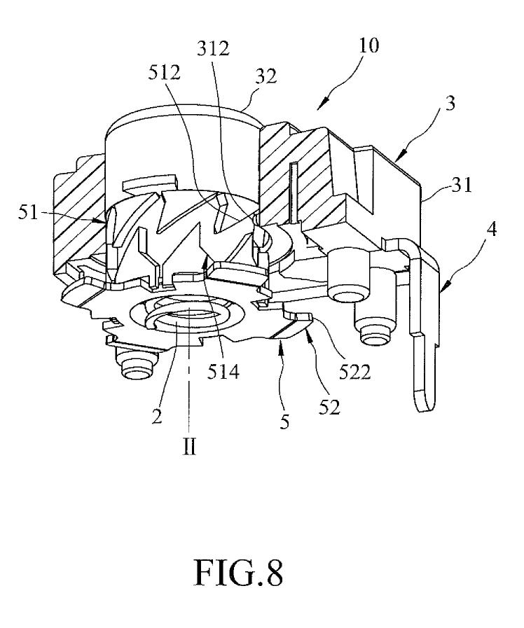

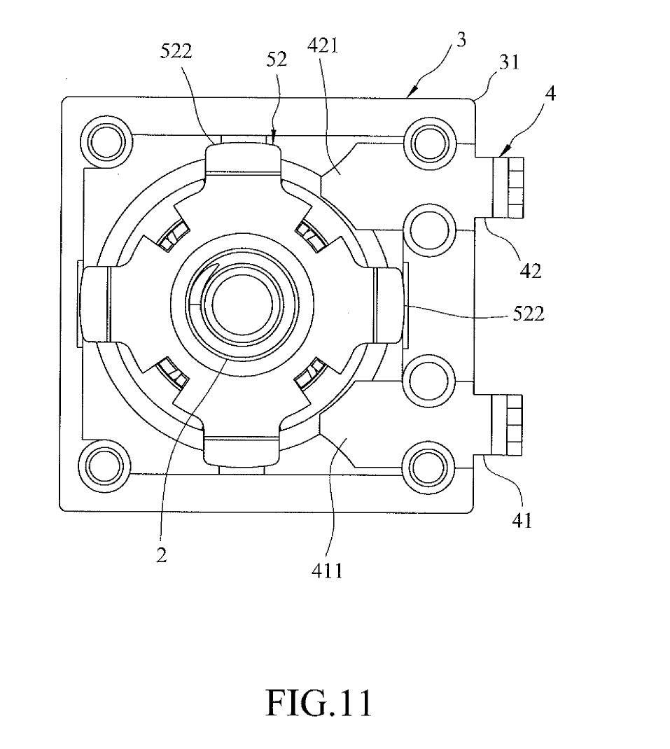

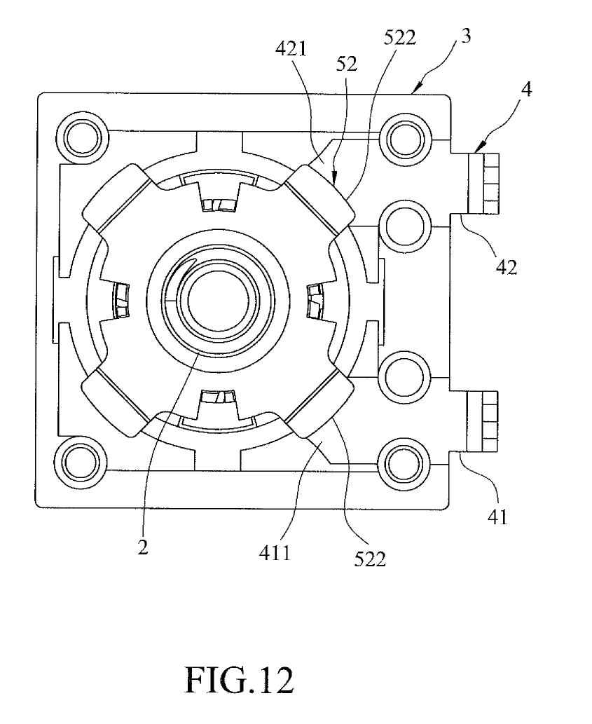

The movable unit 5 is movable relative to the shell body 31 between an upper limit position shown in FIGS. 4, 6, 10A, and 10D, and a lower limit position shown in FIGS. 5, 8, and 10C, and includes a drive member 51 disposed movably and rotatably in the passage 310 in the shell body 31, and an electrical contact member 52 driven by the drive member 51 to move among a plurality of angularly equidistant non-contact positions and a plurality of angularly equidistant contact positions. The non-contact positions are arranged alternately with the contact positions. At the non-contact positions, the electrical contact member 52 is not in contact with the electrical contact unit 4, as shown in FIG. 11, and the movable unit 5 is disposed at the upper limit position. At the contact position, the electrical contact member 52 is in contact with the electrical contact unit 4, as shown in FIG. 12, and the movable unit 5 is also disposed at the upper limit position.

The drive member 51 has a supporting body 510 sleeved on the electrical contact member 52. The supporting body 510 has an annular outer peripheral surface 511 surrounding the axis (II) and the shell body 31 of the cover unit 3 and facing and spaced apart from the inner surrounding surface 311 of the shell body 31 of the cover unit 3, a plurality of upper projections 511′ extending from the outer peripheral surface 511, a plurality of inclined rod-engaging surfaces 512 disposed respectively at the upper projections 511′, a plurality of first guiding surfaces 513 each connected between two adjacent rod-engaging surfaces 512, and a plurality of lower projections 514 extending from the outer peripheral surface 511 and disposed under the upper projections 511′.

The rod-engaging surfaces 512 are located above and face the reference plane 30, and has a lower end 501 proximate to the reference plane 300, and an upper end 502 distal from the reference plane 300. Each first guiding surface 513 extends from the upper end 502 of one of two adjacent rod-engaging surfaces 512 to the lower end 501 of the other of the two adjacent rod-engaging surfaces 512, and cooperates with the one of the two adjacent rod-engaging surfaces 512 to define a first parking space 515.

The lower projections 514 are disposed respectively under the rod-engaging surfaces 512. Each lower projection 514 has a first inclined surface 516 facing and spaced apart from a respective rod-engaging surface 512, a second inclined surface 517, and a second guiding surface 518 connected between upper ends of the first and second inclined surfaces 516, 517. The first inclined surface 516 of each lower projection 514 faces and is adjacent to the second inclined surface 517 to define a second parking space 519 therebetween. Each first guiding surface 513 cooperates with the second guiding surface 518 of the corresponding lower projection 514 to form a return passage 505 for permitting the guide rod 312 to pass therethrough.

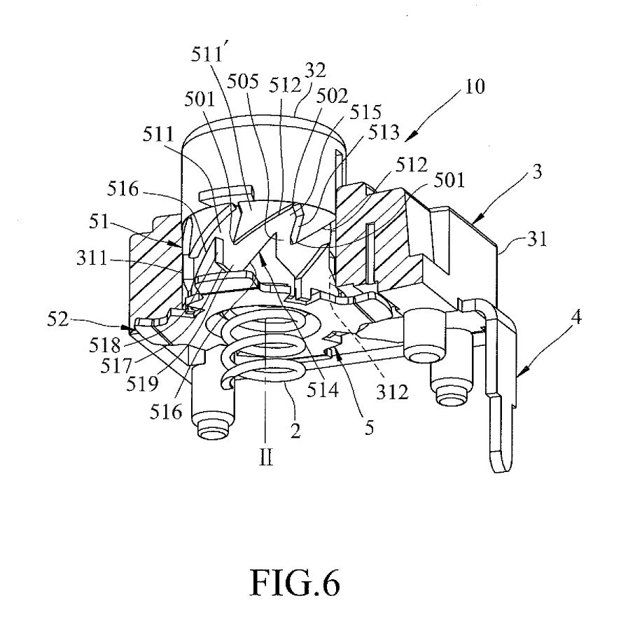

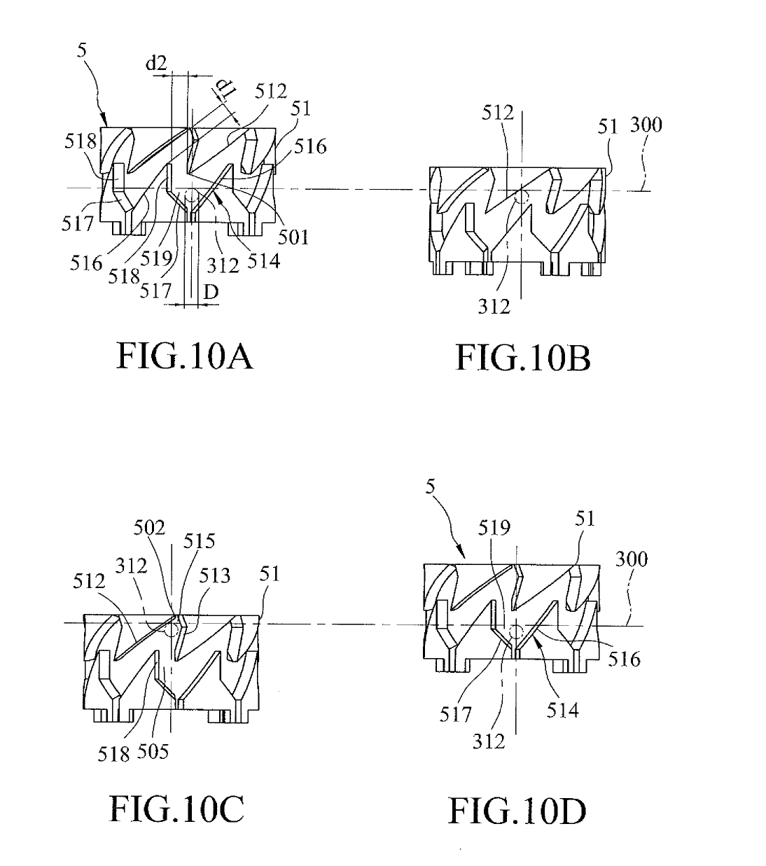

With particular reference to FIGS. 6, 10A, 10B, 10C, and 10D, the upper ends of the first and second inclined surfaces 516, 517 of each lower projection 514 are disposed between lower ends of the first and second inclined surfaces 516, 517 of the corresponding lower projection 514. The upper end of the first inclined surface 516 of each lower projection 514 is aligned vertically with and spaced apart from an intermediate portion of the corresponding rod-engaging surface 512 by a first distance d1. The lower end 501 of each rod-engaging surface 512 is aligned vertically with and spaced apart from the second guiding surface 518 of the corresponding lower projection 514 by a second distance d2. The guide rod 312 has an outer diameter smaller than each of the first and second distances d1, d2.

With particular reference to FIGS. 3, 4, and 6, when the pushbutton 32 is not pressed, the resilient member 2 biases the movable unit 5 so that the guide rod 312 comes into contact with one first inclined surface 516 and one second inclined surface 517, thereby positioning the guide rod 312 in the second parking space 519 defined by the one first inclined surface 516 and the one second inclined surface 517. At this time, a central axis of the guide rod 312 is aligned with a portion of one rod-engaging surface 512 adjacent to the lower end 501, as shown in FIG. 10A, so as to allow the guide rod 312 to move upwardly to contact the one rod-engaging surface 512 when the pushbutton 32 is pressed. Preferably, the length of each rod-engaging surface 512 is greater than the distance between the upper and lower limit positions, so as to maintain slidable contact between the guide rod 312 and one rod-engaging surface 512.

With particular reference to FIGS. 3 and 5, the electrical contact member 52 includes a main body 521 biased by the resilient member 2 to contact the drive member 51, a plurality of equidistant contact projections 522 extending radially and outwardly from a lower end of the main body 521, and a plurality of notches 523 each defined between two adjacent contact projections 522. The main body 521 has a cylindrical portion 524 disposed along the axis (II), and a flange 525 extending radially and outwardly from a lower end of the cylindrical portion 524. The contact projections 522 and the notches 523 are disposed at the flange 525. The supporting body 510 of the drive member 51 is sleeved on the cylindrical portion 524 of the main body 521, and includes a plurality of engaging blocks 530 extending downwardly from a lower end of the supporting body 510.

The shell body 31 of the cover unit 3 further includes two vertical slots 315 formed in the inner surrounding surface 311 and each having an open lower end and a closed upper end 314. The pushbutton 32 includes an annular wall 321 disposed movably within the shell body 31 and abutting against the drive member 51, a top end wall 322 connected integrally to an upper end of the annular wall 321, and two lugs 323 extending radially and outwardly from a lower end of the annular wall 321 and engaging respectively the vertical slots 315, so as to guide vertical movement of the pushbutton 32 relative to the shell body 31.

A process for assembling the pushbutton switch 10 includes the steps of: inverting the shell body 31 so that the connecting posts 316 are located above the guide rod 312;

moving the conductive pins 41 onto the shell body 31 such that they are positioned among the connecting posts 316;

inserting the pushbutton 32 downwardly into the passage 310 in the shell body 31 such that the lugs 323 engage respectively the vertical slots 315;

inserting the drive member 51 into the passage 310 such that the central axis of the drive member 51 is misaligned from that of the passage 310, so as to move the drive member 51 in a side of the passage 310 distal from the guide rod 312 until the guide rod 312 is aligned with a space between the upper projections 511′ and the lower projections 514;

moving the drive member 51 in the passage 310 in a radial direction until the central axes of the drive member 51 and the passage 310 are aligned with each other, and subsequently moving the drive member 51 into contact with the pushbutton 32;

inserting the electrical contact member 52 into the supporting body 510 of the drive member 51 such that the engaging blocks 530 of the drive member 51 engage respectively the notches 523 in the electrical contact member 52;

moving the resilient member 2 into the cylindrical portion 524 of the electrical contact member 52; and

inserting the connecting posts 316 of the shell body 31 into the mounting holes 102 in the base 100 such that the resilient member 2 is sleeved on the support post 101.

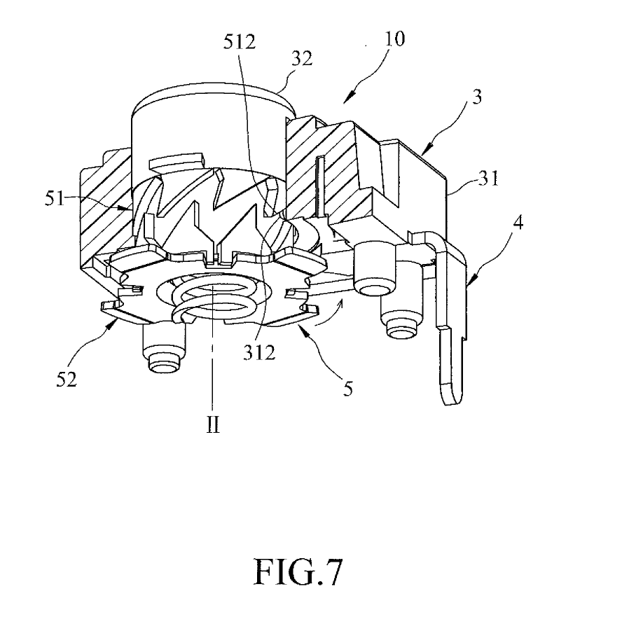

With particular reference to FIGS. 4, 6, 7, 10A, 10B, 10C, and 10D, to change the pushbutton switch 10 from an OFF state to an ON state, it is necessary to apply a downward pressure to the pushbutton 32. Upon application of the downward pressure, the movable unit 5 is pushed by the pushbutton 32 to move downwardly along the axis (II) from the upper limit position until the guide rod 312 comes into contact with one rod-engaging surface 512 to thereby compress the resilient member 2 so that the resilient member 2 provides a biasing force for moving the movable unit 5 upwardly. Thereafter, due to the presence of both the downward pressure and the biasing force applied to the movable unit 5 by the resilient member 2, the one rod-engaging surface 512 moves on the guide rod 312, as shown in FIGS. 10B and 10C such that the movable unit 5 continues to move downwardly and rotates until the guide rod 312 comes into contact with one first guiding surface 513, as shown in FIG. 10C. As soon as the one rod-engaging surface 512 reaches the position shown in FIG. 10C so that downward movement of the movable unit 5 cannot be continued, the movable unit 5 is disposed at the lower limit position, and two contact projections 522 of the electrical contact member 52 are aligned respectively and vertically with and spaced apart from the first ends 411, 421 of the conductive pins 41, 42.

With further reference to FIG. 10D, when the downward pressure is released, the movable unit 5 is biased by the resilient member 2 to move upwardly so that the guide rod 512 passes through the return passage 505. When the movable unit 5 reaches the upper limit position, the guide rod 512 contacts one first inclined surface 516 and one second inclined surface 517, and the contact projections 522 of the electrical contact member 52 come into contact with the first ends 411, 421 of the conductive pins 41, respectively. That is, the pushbutton switch 10 is converted into the ON state. In this manner, the pushbutton 32 can be pressed again and subsequently released to change the pushbutton switch 10 to the OFF state.

With particular reference to FIGS. 6, 10A, 10B, 10C, and 10D, the inclination angle of each rod-engaging surface 512 can be adjusted according to the distance between the upper and lower limit positions. Preferably, each rod-engaging surface 512 forms an angle of 25°, 302 , 45°, 60°, or 75° with respect to the reference plane 300. When it is desired to reduce the time required to press the pushbutton 32 to convert the pushbutton witch 10 between the ON and OFF states, the length of each rod-engaging surface 512 needs to be decreased.

Alternatively, the number of the guide rod 312 can be increased. For example, a plurality of guide rods 312 are disposed in the shell body 31, and correspond respectively to the rod-engaging surfaces 512.

In view of the above, the pushbutton switch 10 of this invention has the following advantages:
1. Through cooperation between the guide rod 312 of the shell body 31 of the cover unit 3 and the rod-engaging surfaces 512 of the drive member 51, downward movement of the pushbutton 32 can be converted into downward movement and rotation of the movable unit 5. As such, the structure of the pushbutton switch 10 is simple, thereby reducing the manufacturing costs.
2. Contact area between the guide rod 312 and the rod-engaging surfaces 512 is relatively small. This facilitates smooth operation of the pushbutton 32, and reduces noise produced due to friction during operation.
3. Since the resilient member 2 can bias the movable unit 5 to move from the lower limit position to the upper limit position, the lower projections 514 may be omitted from the drive member 51. If the lower projections 514 are omitted, noise produced due to striking of the guide rod 312 on the drive member 51 can be reduced. If the lower projections 514 are not omitted, since contact area between the guide rod 312 and the lower projections 514 is small, such a noise still can be slightly reduced.

With this invention thus explained, it is apparent that numerous modifications and variations can be made without departing from the scope and spirit of this invention. It is therefore intended that this invention be limited only as indicated by the appended claims.

I claim:

1. A pushbutton switch adapted to be mounted on and above a base, said pushbutton switch comprising:
a resilient member adapted to be disposed on the base along an axis;
a cover unit including a shell body adapted to be connected with the base to define an accommodating space therebetween, which receives said resilient member, said shell body including an inner surrounding wall surface surrounding said axis and defining a passage in spatial communication with said accommodating space, and at least one guide rod extending from said inner surrounding wall toward said axis and defining a reference plane that is perpendicular to said axis, said guide rod having an upper side located in the reference plane;
an electrical connection unit adapted to be disposed between said cover unit and the base and extending into said accommodating space; and
a movable unit disposed between said resilient member and said cover unit and movable relative to said shell body between an upper limit position and a lower limit position disposed under said upper limit position, said movable unit including a drive member disposed movably and rotatably in said passage, and an electrical contact member driven by said drive member to move between a plurality of contact positions and a plurality of non-contact positions, said drive member having a plurality of inclined rod-engaging surfaces, each of said rod-engaging surfaces having a lower end proximate to said reference plane, and an upper end distal from said reference plane such that, when said movable unit is moved from said upper limit position to said lower limit position, one of said rod-engaging surfaces is in slidable contact with said guide rod, thereby resulting in rotation of said drive member relative to said shell body.

2. The pushbutton switch as claimed in claim 1, wherein said guide rod of said shell body of said cover unit has a circular cross-section.

3. The pushbutton switch as claimed in claim 1, wherein said drive member of said movable unit further has a plurality of first guiding surfaces, each of said first guiding surfaces being connected between two adjacent ones of said rod-engaging surfaces and extending from said upper end of one of said two adjacent ones of said rod-engaging surfaces to said lower end of the other of said two adjacent ones of said rod-engaging surfaces, each of said first guiding surfaces cooperating with said one of said two adjacent ones of said rod-engaging surfaces to define a first parking space therebetween, which allows said guide rod to be disposed therein when said movable unit is disposed at said lower limit position.

4. The pushbutton switch as claimed in claim 3, wherein said drive member of said movable unit further has an annular outer peripheral surface surrounding said axis and facing and spaced apart from said inner surrounding surface of said shell body, and a plurality of upper projections extending from said outer peripheral surface, said rod-engaging surfaces being disposed respectively at said upper projections, said first guiding surfaces being disposed respectively at said upper projections, said drive member further having a plurality of lower projections extending from said outer peripheral surface and disposed under said upper projections, each of said lower projections having a first inclined surface facing a respective one of said rod-engaging surfaces, a second inclined surface, and a second guiding surface connected between upper ends of said first and second inclined surfaces, such that said upper ends of said first and second inclined surfaces are disposed between lower ends of said first and second inclined surfaces, said upper end of said first inclined surface of each of said lower projections being being aligned vertically with and spaced apart from an intermediate portion of a corresponding one of said rod-engaging surfaces by a first distance, said lower end of each of said rod-engaging surfaces being spaced apart from said second guiding surface of a corresponding one of said lower projections by a second distance, said first inclined surface of each of said lower projections facing and being adjacent to said second inclined surface of an adjacent one of said lower projections to define a second parking space therebetween, which allows said guide rod to be disposed therein when said guide rod is disposed at said upper limit position, said guide rod having an outer diameter smaller than each of said first and second distances.

5. The pushbutton switch as claimed in claim 4, wherein each of said first guiding surfaces cooperates with said second guiding surface of a corresponding one of said lower projections to form a return passage permitting said guide rod to pass therethrough.

6. The pushbutton switch as claimed in claim 1, wherein each of said rod-engaging surfaces forms an angle with respect to said reference plane, said angle being one of 25°, 30°, 45°, 60°, and 75°.
